(19) United States
(12) Patent Application Publication
(10) Pub. No.: US 2007/0162546 A1
(43) Pub. Date: Jul. 12, 2007

(54) SHARING TAGS AMONG INDIVIDUAL USER MEDIA LIBRARIES

(75) Inventor: Matt McLaughlin, Corvallis, OR (US)

Correspondence Address: STOEL RIVES LLP, 900 SW FIFTH AVENUE, SUITE 2600, PORTLAND, OR, 97204-1268, US

(73) Assignee: MusicStrands, Inc., Corvallis, OR (US)

(21) Appl. No.: 11/613,005

(22) Filed: Dec. 19, 2006

Related U.S. Application Data
(60) Provisional application No. 60/753,042, filed on Dec. 22, 2005.

(51) Int. Cl. G06F 15/16

(52) U.S. Cl. 709/204

(57) ABSTRACT

A system and method are disclosed for unifying tags of a media user community by transferring user-supplied tags between individual user media libraries. One aspect comprises a process for identifying, within a user community, common tags associated with media items and common media items associated with tags by cross-referencing media items and corresponding tags among individual media user libraries. The system in one embodiment provides a user with a unified classification of tags, which can be used to search, navigate and organize an individual user's media library.

### RELATED APPLICATION

This application is a non-provisional of U.S. Provisional Application No. 60/753,042 filed Dec. 22, 2005. Applicant accordingly claims priority from said provisional application which is incorporated herein in its entirety by this reference.

### COPYRIGHT NOTICE

© 2005-2006 Musicstrands, Inc. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever 37 CFR § 1.71(d).

### TECHNICAL FIELD

This invention relates generally to search and navigation systems for managing and locating digital media items, for example articles, songs or movie clips, using user-supplied tags, and in particular to search and navigation and organization of tags shared among a community of media users.

### BACKGROUND OF THE INVENTION

On the internet and with other communication networks, “tagging” is quickly replacing the traditional search and bookmark methods as the preferred way for users to navigate and organize data. Tags in general are user-supplied words or phrases that can be associated with particular data or files to facilitate easy retrieval of that data. The data can be of any type, but commonly it includes web pages or portions thereof. Typically, both the tags and the data items to which they are associated are stored on websites, and are available to all users.

Storage of such information on publicly-accessible websites can be problematic, however, for users who are concerned with retaining their privacy and property rights. Users may have proprietary rights in the data items themselves, the associated tags, or both.

### BRIEF DESCRIPTION OF THE DRAWINGS

FIG. 1 is a block diagram of a client-server process for transferring tags between user libraries according to an embodiment of the present invention.

FIG. 2 is a block diagram of a peer-to-peer process for transferring tags between user libraries according to an embodiment of the present invention.

FIG. 3 is a flow diagram of a process for resolving a user library according to an embodiment of the present invention.

FIG. 4 is a flow diagram for a process for adding a transferable tag to a system according to an embodiment of the present invention.

FIG. 5 is a flow diagram of a process for retrieving relevant community tags according to an embodiment of the present invention.

FIG. 6 is a flow diagram of a process for peer-to-peer tag sharing according to an embodiment of the present invention.

### DETAILED DESCRIPTION OF SOME PREFERRED EMBODIMENTS

The present invention ameliorates the challenges described above by, in some embodiments, allowing the media items to remain on the individual user's library (e.g. a local disk drive) while allowing tags for the media items to persist on the local machine but also across other users' local machines. Users can continue to benefit from the community of media users, through tag sharing, while at the same time maintaining control of their media items on their local libraries.

With users preferring to retain their media items on their local libraries, user libraries grow very large, and it is becomes increasingly more difficult to search and retrieve media items. With the present invention a meaningful “folksonomy” can be created and the individual user's media library can easily be searched and organized using universal tags.

Embodiments of the present invention provide systems and methods for transferring user-supplied tags between individual user media libraries. In embodiments of the present invention the term “tag” refers to a form of metadata, which is a freely chosen user-supplied word or short phrase associated with a media item. The term “metadata” refers generally to any data associated with a media item e.g. media item identification, user identification, tags, etc. The term “attribute” generally refers to unique information associated with media items in a user library including metadata, signal analysis, unique ID number, etc.

One embodiment comprises a client-server system, which allow tags to persist on a local machine but across multiple local machines where media items may be stored. After tags are transferred between client and server and then between server and another client, tags are stored on the local machine along with media items, providing privacy and the ability to browse media items using tags offline. A server identifies a tag, a user, a media item, and any other items with which the media item is associated. The server maps the correlating identifications and sends the correlated data to a user's local library.

Another embodiment of the invention uses a standard peer-to-peer system in which tags are stored and sent in an XML format file that associates tags with an item or set of items.

Additional aspects and advantages will be apparent from the following detailed description of preferred embodiments. The illustrated embodiments and features are offered by way of example and not limitation.

Reference is now made to the figures in which like reference numerals refer to like elements. For clarity, the first digit of a reference numeral indicates the figure number in which the corresponding element is first used. In the following description, certain specific details of programming, software modules, user selections, network transactions, database queries, database structures, etc., are provided for a thorough understanding of the embodiments of the invention. However, those skilled in the art will recognize that the invention can be practiced without one or more of the specific details, or with other methods, components, materials, etc.

In some cases, well-known structures, materials, or operations are not shown or described in detail in order to avoid obscuring aspects of the invention. Furthermore, the described features, structures, or characteristics may be combined in any suitable manner in one or more embodiments. In general, the methodologies of the present invention are advantageously carried out using one or more digital processors, for example the types of microprocessors that are commonly found in PC's, laptops, PDA's and all manner of desktop or portable electronic appliances.

Definitions: Subject to the preceding two paragraphs, the following terms, as used herein, have the meanings set forth below, and further include items or actions that provide similar functionality.

A tag is a freely chosen or arbitrary user-supplied word or short phrase associated with a media item.

A folksonomy is a system of user-supplied tags, usually a collaborative categorization using freely chosen keywords. Individual users can have their own folksonomies, and a community of users can share a folksonomy.

A media item can be any item of an expressive nature, e.g. a song, a book, a newspaper, a movie, a segment of a radio program, etc.

Attribute generally refers to unique information associated with media items in a user library including metadata, signal analysis, etc.

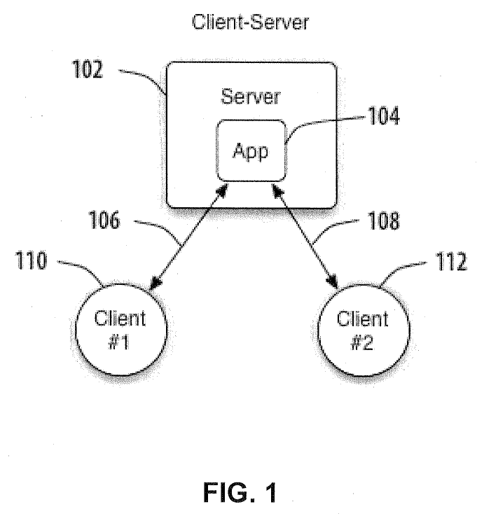

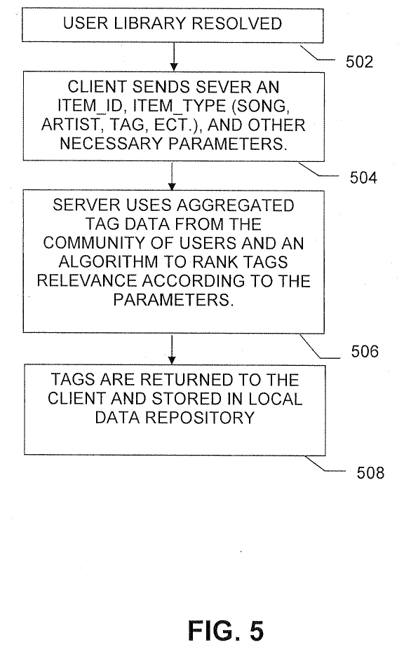

FIG. 1 illustrates a general overview of a client-server network for sharing tags between users 100. According to one embodiment of the present invention, an application 104 in a server 102 is implemented in a ranking the relevance of tags according to certain parameters 506 (FIG. 5) and returns the tags to the client 106.

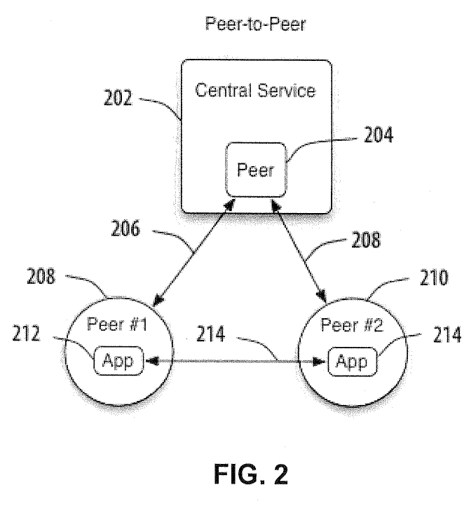

FIG. 2 illustrates a general overview of a peer-to-peer network for sharing tags between users 200. In FIG. 2, when one client is known to another, tags can be directly transferred between clients without the facilitation of a server 216.

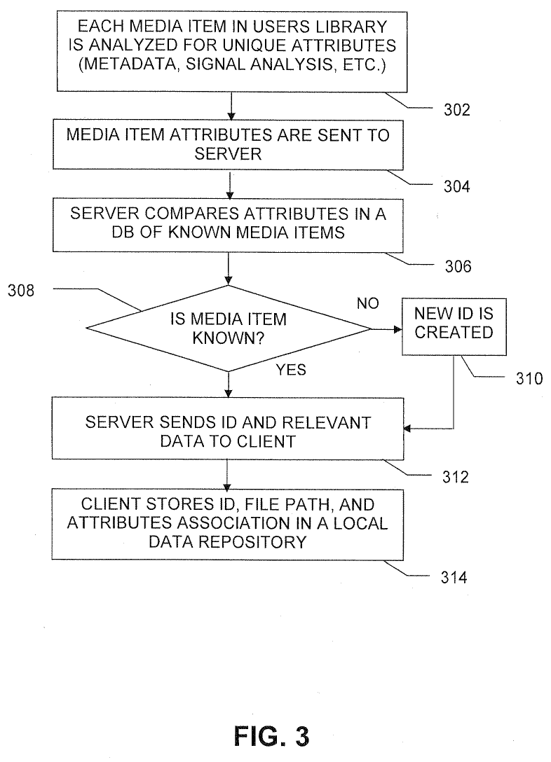

FIG. 3 is a flow diagram of a process for resolving a user library 300. Each media item in a user's library is analyzed for unique attributes e.g. metadata, signal analysis, etc. 302. The media item attributes are sent to a server 304. The server compares the attributes of the user media library to a database of known media items 306. The server decides if the media item is known 308. If the media item is known in the database, the server sends an ID and relevant data to a client 312. If a media item is not known, the server creates a new media item ID 310 and sends the new ID and relevant data to a client 312. The client stores ID, file path, and attributes association in a local data repository 314.

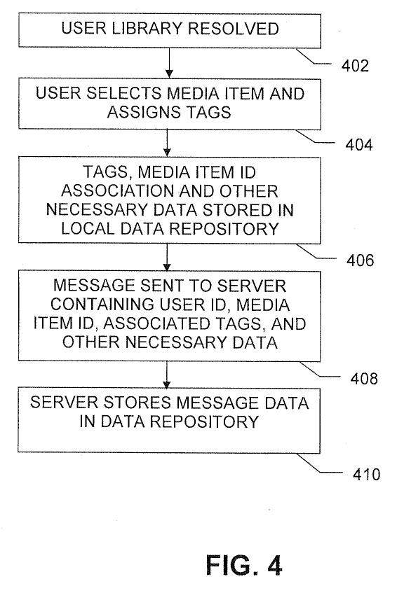

FIG. 4 is a flow diagram of a process for adding a transferable tag to a system 400. In step 402, a user library is resolved 300 (FIG. 3). A user selects a media item and assigns a tag in step 404. Tags, media item ID association and other necessary data is stored in a local data repository 406. A message is sent to a server, which contains a user ID, a media item ID, all associated tags, and other necessary data 408. A server stores the message data in a data repository 410.

FIG. 5 is a flow diagram of a process 500 for retrieving relevant community tags that may be implemented in the client-server process for sharing tags 106 and 108 (FIG. 1). At step 502, a user library is resolved 300 (FIG. 3). A client sends a server an item ID, an item type (song, artist, tag, etc.), and associated metadata at step 504. The server then uses this information to extract the most relevant community tags (i.e., tags from a community-wide collection or database). Community tags on the server are associated to an item based on metadata, so a relevance algorithm is typically based on matching on this metadata. For example, if a user sends data representing the song “Born to run” on the album “Born to run” by “Bruce Springsteen”, an algorithm in one embodiment could extract (in order of relevance):
1) tags associated to tracks of the album “Born to run”
2) tags associated to the album “Born to run”
3) tags associated to the artist “Bruce Springsteen”
4) tags associated to the genre “rock” and decade “80”
5) etc . . .

This is just an example of how a simple ranking algorithm to extract tags associated to an item (with metadata) could work. Extracted tags are then returned to the client and stored in the local data repository 508.

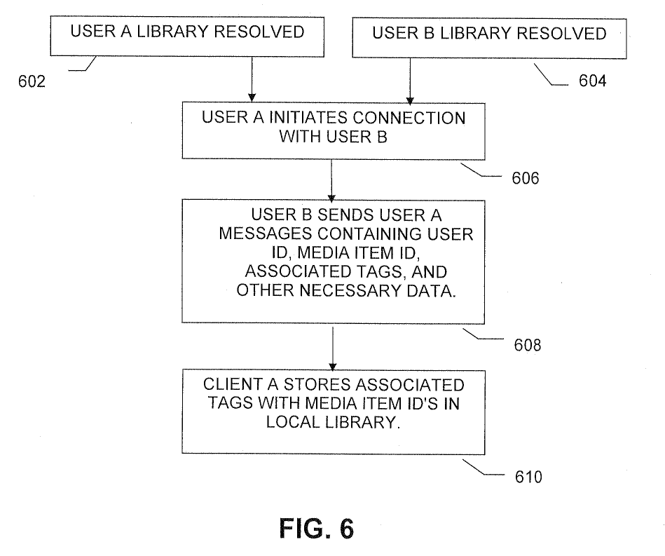

FIG. 6 is a flow diagram that details the peer-to-peer tag sharing process 216 (FIG. 2). At steps 602 and 604, user libraries are resolved 300 (FIG. 3). User A initiates connection with user B at step 606. User B sends user A messages containing user ID, media item ID, associated tags, and other necessary data 608. Client A then stores associated tags with media item ID's in the local library at step 610.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, there are used in a generic and descriptive sense only and not for purposes of limitation.

It will be obvious to those having skill in the art that many changes may be made to the details of the above-described embodiments without departing from the underlying principles of the invention. The scope of the present invention should, therefore, be determined only by the following claims.

1. A method of sharing tags among a user community comprising:
receiving from a user a unique attribute of a media item;
comparing the unique attribute to a predetermined database of known media items to determine a matching media item; and
if a match is found, reading an ID of the matching media item from the database and sending the ID of the matching media item to the user.

2. A method according to claim 1 and further comprising, if a match is found, reading additional metadata associated with the matching media item from the database and sending the metadata to the user along with the ID of the matching item.

3. A method according to claim 1 and further comprising, if a match is not found in the database, assigning a new ID number to the media item, returning the assigned ID number to the user, and adding the ID number to the database in association with the received unique attribute of a media item.

4. A method according to claim 1 wherein the unique attribute comprises metadata.

5. A method of sharing tags among a network user community comprising:
receiving media item tag data from a plurality of users, the tag data comprising, for each media item, identification of the contributing source, the media item ID, and a tag;
storing the received tag data to form a community tag data repository;
receiving a query from one of the users, the query comprising a media item ID, a media item type, and metadata associated with the identified media item;
searching the community tag data repository to extract media item tags having associated metadata that are similar to the metadata provided in the query; and
returning the extracted tags to the user in response to the received query.

6. A method of sharing tags according to claim 5 including returning the associated metadata for each of the tags extracted and returned to the user.

7. A method of sharing tags according to claim 5 wherein:
the query comprises a media item tag;
and the query media item tag is one of a predetermined set of universal tags.

8. A method of sharing tags according to claim 5 and further comprising determining a set of universal tags responsive to the tag data received from the users.

9. A method of sharing tags according to claim 8 and further comprising sending the determined set of universal tags to a user for the user to employ in tagging media items in a local library.

10. A method of sharing tags according to claim 5 including:
receiving indicia from a user that identifies a media item;
searching the data depository to locate data associated with the identified media item, the associated data including a universal tag; and
returning the universal tag to the user for the user to employ in association with the identified media item.

11. A method of sharing tags according to claim 5 and further comprising sharing the located data with another user of the network user community.

12. A machine-readable medium storing executable code to implement the method of claim 5.
